(19) United States
(12) Patent Application Publication
(10) Pub. No.: US 2008/0069094 A1
(43) Pub. Date: Mar. 20, 2008

(54) Urgent packet latency control of network on chip (NOC) apparatus and method of the same

(75) Inventors: Beom Hak Lee, Yongin-si (KR); Eui Seok Kim, Yongin-si (KR); Sang Woo Rhim, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/644,909

(22) Filed: Dec. 26, 2006

(30) Foreign Application Priority Data
Sep. 19, 2006 (KR) 10-2006-0090565

(51) Int. Cl. H04L 12/56

(52) U.S. Cl. 370/389

(57) ABSTRACT

An urgent packet latency control of a network on chip (NoC) apparatus and a method of urgent packet latency control of a NoC are provided. The urgent NoC packet latency control apparatus includes: an urgent packet determination unit which determines whether a packet is an urgent packet based on a predetermined field of the packet; an urgent packet path search unit which searches for at least one router, included in a routing path of the urgent packet, if the urgent packet determination unit determines that the packet is urgent; and an urgent packet path control unit which transmits output port information of the urgent packet to the router.

### CROSS-REFERENCE TO RELATED APPLICATIONS

This application claims priority from Korean Patent Application No. 10-2006-0090565, filed on Sep. 19, 2006, in the Korean Intellectual Property Office, the entire disclosure of which is incorporated herein by reference.

### BACKGROUND OF THE INVENTION

1. Field of the Invention

Apparatuses and methods consistent with the present invention relate to network on chip (NoC) packet latency, and more particularly, to an NoC packet latency managing apparatus and an NoC packet latency managing method capable of reducing the NoC packet latency.

2. Description of the Related Art

The convergence of a computer, communication, broadcasting, and the like has been shifting the demand for an application specific integrated circuit (ASIC) and an application specific standard product (ASSP) into the demand for a system-on-chip (SoC). As the SoC industry is developing, an information technology (IT) device is becoming smaller, lighter, simpler, and more highly functioned.

The SoC is a semiconductor technology of integrating all components or other electronic system into a single chip. Various technologies related to the SoC have been studied. Particularly, a method of connecting many intellectual properties which are embedded in a chip is considered critical.

A connection method based on a bus is a mainly used to connect the intellectual properties. However, as a degree of integration of the chip becomes higher and an amount of information flow between the intellectual properties increases, the SoC using the bus structure is reaching its design limitations.

To overcome the design limitations, a network-on-chip (NoC) technology has been proposed. The NoC connects the intellectual properties by applying a general network technology within a chip.

The NoC is a network style on-chip interconnect (OCI) to overcome the design limitation of the SoC. Through the NoC, fast, energy-efficient, and high performance of the SoC may be embodied.

A large number of routers to transmit a packet are configured in the NoC. The router transmits a packet, input from the intellectual property or another router, to a subsequent router or another connected intellectual property. In this case, the router outputs the input packet after undergoing an operation illustrated in FIG. 1 when the packet is input, and time is required to perform the operation illustrated in FIG. 1. Accordingly, a large amount of latency is incurred until the packet arrives at a destination when a great number of routers are included in a routing path.

In a related art, there is a method which can reduce the latency of the packets by making a path that directly connects the great number of routers with each other. However, in the related art method, wire complexity and a gate count increase since many routers are directly connected.

Accordingly, a new NoC packet latency managing apparatus which can reduce the latency of the packet in the NoC and lessen the wire complexity is required.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides an urgent NoC packet latency control apparatus and an urgent NoC packet latency control method which can reduce latency, i.e. a period of time to a destination, when an urgent packet is input.

The present invention also provides an urgent NoC packet latency control apparatus and an urgent NoC packet latency control method which can reduce latency of a packet and reduce manufacturing costs.

The present invention also provides an urgent NoC packet latency control apparatus and an urgent NoC packet latency control method which can reduce latency of a packet by reducing wire complexity.

According to an aspect of the present invention, there is provided an urgent NoC packet latency control apparatus including: an urgent packet determination unit determining whether a packet is urgent by using a predetermined field of the packet; an urgent packet path search unit searching for a router, included in a routing path of the urgent packet, when the packet is urgent; and an urgent packet path control unit transmitting output port information of the urgent packet to each router, included in the routing path.

In this case, output port information of the urgent packet may correspond to an advanced output port request among an input signal of the router.

In this case, the NoC may operate according to static routing.

According to another aspect of the present invention, an urgent NoC packet latency control apparatus including: a packet path search unit searching for a router, included in a routing path of a packet when the packet is input; and a latency control apparatus transmitting output port information of the packet to a subsequent router to which the packet is input, included in the routing path.

In this case, the output port information of the packet may correspond to an advanced output port request among an input signal of the router.

In this case, the NoC packet may be a router connected with a master intellectual property, generating the packet.

In this case, the NoC may operate according to static routing.

According to an aspect of the present invention, there is provided an urgent NoC packet latency control method including: determining whether a packet is an urgent packet by using a predetermined field of the packet; searching for a router, included in a routing path of the urgent packet, when the packet is the urgent packet; and transmitting output port information of the urgent packet to each router, included in the routing path.

### BRIEF DESCRIPTION OF THE DRAWINGS

The above and other aspects of the present invention will become apparent and more readily appreciated from the following detailed description of certain exemplary embodiments of the invention, taken in conjunction with the accompanying drawings of which:

FIG. 1 is a diagram illustrating operations from inputting to outputting of a packet in a general router according to a related art;

FIG. 2 is a block diagram illustrating a configuration of an urgent NoC packet latency control apparatus according to an exemplary embodiment of the present invention;

FIG. 3 is a diagram illustrating a configuration of a header flit used in an exemplary embodiment of the present invention;

FIG. 4 is a diagram illustrating a configuration of a router which configures an NoC according to an exemplary embodiment of the present invention;

FIG. 5 is a diagram illustrating a priority with respect to an internal arbitration algorithm of an arbiter of FIG. 4:

FIG. 6 is a block diagram illustrating a configuration of an urgent NoC packet latency control apparatus according to another exemplary embodiment of the present invention;

FIG. 7 is a diagram illustrating operation S610 of FIG. 6;

FIG. 8 is a flowchart illustrating an urgent NoC packet latency control method according to an exemplary embodiment of the present invention; and

FIG. 9 is a flowchart illustrating an urgent NoC packet latency control method according to another exemplary embodiment of the present invention.

### DETAILED DESCRIPTION OF EXEMPLARY EMBODIMENTS OF THE INVENTION

Reference will now be made in detail to exemplary embodiments of the present invention, examples of which are illustrated in the accompanying drawings, wherein like reference numerals refer to the like elements throughout. The exemplary embodiments are described below in order to explain the present invention by referring to the figures.

An NoC will be described in the specification on the assumption that the NoC operates according to static routing.

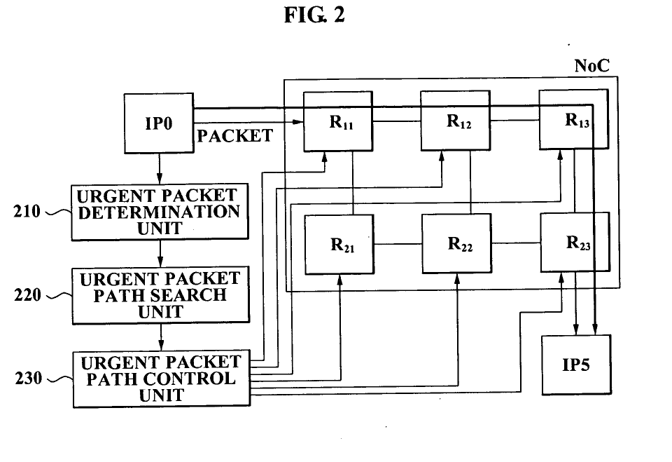

FIG. 2 is a block diagram illustrating a configuration of an urgent NoC packet latency control apparatus according to an exemplary embodiment of the present invention, and the configuration is to reduce latency when the urgent packet to be urgently processed is input. In this case, it is assumed that the NoC includes six routers, and an urgent packet, generated by an intellectual property IP0, is transmitted to an intellectual property IP5.

Referring to FIG. 2, the urgent NoC packet latency control apparatus includes an urgent packet determination unit 210, an urgent packet path search unit 220, and an urgent packet path control unit 230.

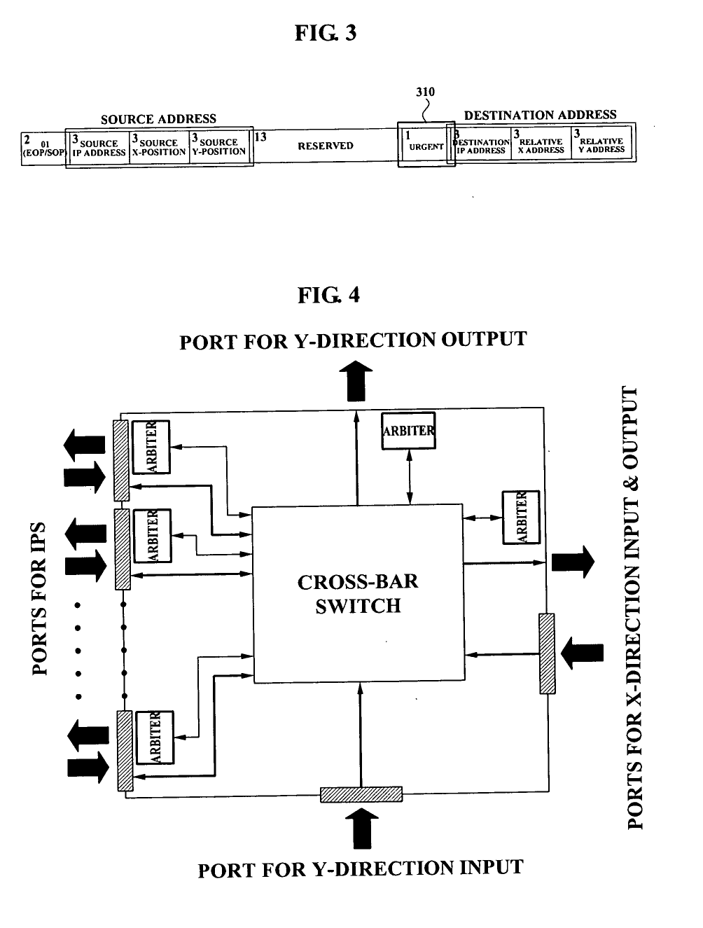

The urgent packet determination unit 210 determines whether a packet, generated by an intellectual property, is an urgent packet by using a predetermined field of the packet. Referring to FIG. 3, a description regarding the urgent packet determination unit 210 is given as follows.

FIG. 3 is a diagram illustrating a configuration of a header flit used in an exemplary embodiment of the present invention.

As illustrated in FIG. 3, the header flit includes a source address recording where the packet was generated, a destination address recording where the packet is to be received, and a reserved field including an urgent field 310 to determine an urgent packet.

The urgent field 310 is a field to determine whether the packet, generated by the intellectual property, is an urgent packet, and the urgent packet determination unit 210 uses the urgent field value in FIG. 3 to determine whether the packet is urgent. As an example, when the urgent field value is ‘1’, it is determined the packet is urgent, and when the urgent field value is ‘0’, it is determined the packet is not urgent. The urgent packet path search unit 220 searches for a router, included in a routing path, using the routing path of the urgent packet. In this case, routers R₁₁, R₁₂, R₁₃ through R₂₃ may correspond to the routers, included in the routing path.

In this case, output port information of the urgent packet may include any one of an X router, a Y router, and an intellectual property when an NoC operates according to an XY routing.

In this case, the routing path may be checked using a source address field where the urgent packet is generated, and a destination address field where the urgent packet is received since the NoC operates according to static routing. Specifically, the routing path may be checked using a source address and a destination address of the header flit in FIG. 3. In this case, the routing path may be checked by referring to a look-up table where the routing path is established using the source address and the destination address.

Specifically, the urgent packet path search unit 220 may check the urgent packet, generated by the intellectual property IP0, is transmitted to the intellectual property IP5 via the routers R₁₁, R₁₂, R₁₃, and R₂₃ by using the looked-up routing path.

The urgent packet path control unit 230 outputs the output port information of the urgent packet to each of the routers R₁₁, R₁₂, R₁₃ through R₂₃, included in the routing path of the urgent packet looked-up by the urgent packet path search unit 220. In this case, the output port information of the urgent packet to be output to each of the routers R₁₁, R₁₂, R₁₃, and R₂₃ may be identical to each other or different from each other. Specifically, the routers R₁₁ and R₁₂, may have an identical output port information since an output port of the urgent packet is the X router, i.e., an output port of the router R₁₁ is X router R₁₂ and an output port of the router R₁₂ is an X router R₁₃ Conversely, output port information of the router R₁₃ may different from the output port information of the urgent packet of the routers R₁₁ and R₁₂ since an output port of the urgent packet is a Y router R₂₃

In this case, the output port information of the urgent packet corresponds to an advanced output port request, among input signals of an internal arbitration algorithm of the arbiter configuring the router, which will be described with reference to FIG. 4.

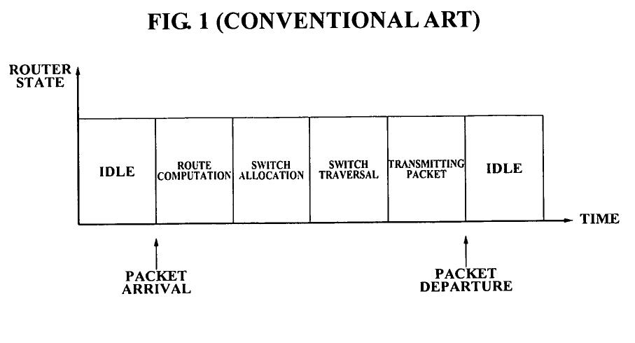

Specifically, each of the routers R₁₁, R₁₂, R₁₃, and R₂₃ receives the output port information of the urgent packet, transmitted by the urgent packet path control unit 230, and connects input/output ports to be passed through by the urgent packet in advance, subsequently the urgent packet, generated by the intellectual property IP0, may be relatively quickly transmitted to the intellectual property IP5. Thus, the latency may be reduced since the operation illustrated in FIG. 1 may be omitted when the each of the routers R₁₁, R₁₂, R₁₃, and R₂₃ receive and output the packet.

In FIG. 2, the urgent NoC packet latency control apparatus is configured as three functional parts, i.e. the urgent packet determination unit 210, the urgent packet path search unit 220, and the urgent packet path control unit 230, however the urgent NoC packet latency control apparatus may be configured as one functional part, which includes all of the three functional parts.

FIG. 4 is a diagram illustrating a configuration of a router which configures an NoC according to an exemplary embodiment of the present invention.

Referring to FIG. 4, the router includes a cross-bar switch, input/output ports, e.g., XY direction input/output ports and input/output ports for intellectual properties, and an arbiter.

A description regarding the cross-bar switch and the input/output ports will be omitted since the cross-bar switch and the input/output ports would be appreciated by those of ordinary skill in the art.

The arbiter performs arbitrating of a bus ownership and operates according to an internal arbitration algorithm of the arbiter.

The arbiter of the present invention operates according to the arbitration algorithm, embodied as a fixed priority.

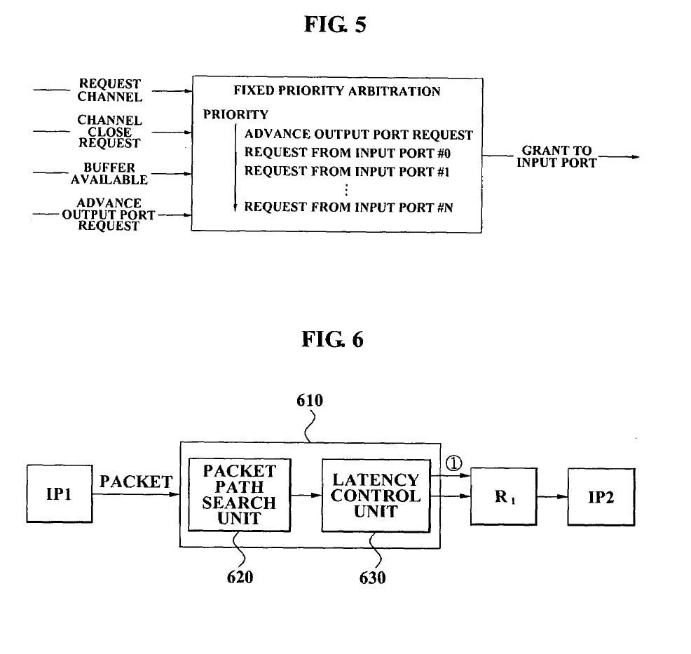

FIG. 5 is a diagram illustrating a priority with respect to an internal arbitration algorithm of an arbiter of FIG. 4.

As illustrated in FIG. 5, among signals input to a router, output port information of an urgent packet corresponds to an advance output port request in a fixed priority arbitration.

Specifically, input request signals are sequentially processed using the priority determined according to the arbitration algorithm when at least one request signal is input to the arbiter.

As an example, the arbitration algorithm allows the output port information of the urgent packet corresponding to an advanced output port request to use an input port of a subsequent router when request signals illustrated in FIG. 5, e.g., a request channel, a channel close request, a buffer available, and the advanced output port request, are input.

Thus, latency of the urgent packet may be reduced since the time required to transmit the urgent packet, generated by the intellectual property IP0, to the intellectual property IP5 is reduced by the output port information of the urgent packet, output from the urgent packet path control unit 230 of FIG. 2, to each of the routers R₁₁, R₁₂, R₁₃, and R₂₃ included in the routing path.

The urgent packet may be used for operations to be urgently processed, e.g., control information, status register update, and a lock operation.

FIG. 6 is a block diagram illustrating a configuration of an urgent NoC packet latency control apparatus 610 according to another exemplary embodiment of the present invention, and the urgent NoC packet latency control is an apparatus capable of reducing latency of one router.

Referring to FIG. 6, the urgent NoC packet latency control apparatus 610 of the present invention includes a packet path search unit 620 and a latency control unit 630.

The packet path search unit 620 checks a routing path of a packet, generated by an intellectual property IP1, and searches for a router included in the routing path.

In this case, the packet path search unit 620 searches the routing path using a source address field and a destination address field included in the packet. In this case, the routing path may be searched since an NoC operates according to static routing.

The latency control unit 630 receives the packet, generated by the intellectual property IP1, and transmits output port information \textcircled{1} of the packet to a subsequent router R1, included in the routing path searched by the packet path search unit 620.

In this case, the output port information of the packet transmitted from the latency control unit 630 may include any one of an X router, a Y router, and an intellectual property when the NoC operates according to an XY routing.

In this case, the output port information of the packet is given priority and processed first when a plurality signals are simultaneously input to the router since the output port information of the packet corresponds to an advanced output port request, among input signals of an internal arbitration algorithm of the arbiter configuring the router.

Namely, the subsequent router R1 receives the output port information of the packet, transmitted from the latency control unit 630, and connects input/output ports to be passed through by the packet in advance, subsequently the latency may be reduced in comparison to the operation illustrated in FIG. 1.

The packet path search unit 620 and the latency control unit 630 are separately configured in FIG. 6, however the latency control unit 630 may be configured by including the function of the packet path search unit 620. Namely, the router may be configured by combining the packet path search unit 620 and the latency control unit 630 together.

In this case, the router formed by the packet path search unit 620 and the latency control unit 630 together may be a desirable router configuring the NoC.

In this case, the urgent NoC packet latency control unit 610 is desirably connected to a master IP generating the packet.

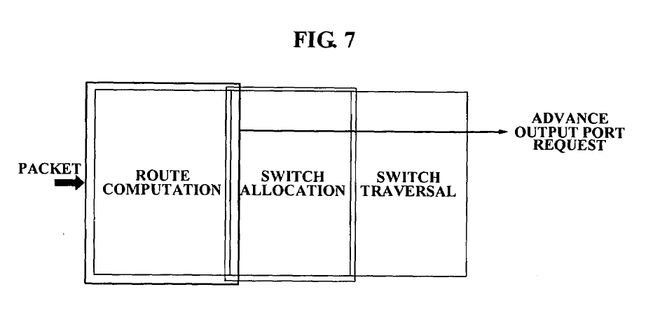

In this case, the urgent NoC packet latency control unit 610, i.e., the router connected to the master IP, receives the packet generated by the master intellectual property, transmits the output port information of the packet to the subsequent router R1 via route computation among input/output process operations, i.e., route computation, switch allocation and switch traversal in FIG. 7, and the subsequent router R1 directly transmits the packet to an intellectual property IP2 eliminating the need for the operations of FIG. 1, therefore the latency in the subsequent router R1 may be reduced.

In this case, the output port information of the packet may include the output port information with respect to the X router, the Y router, and an IP when the NoC operates according to the XY routing, which is represented as,

TABLE 1

| | Output port Information of Packet |
|---|---|
| X-out | 3′b001 |
| Y-out | 3′b010 |
| IP-out | 3′b100 |

As illustrated in FIG. 1, the router may check the output information regarding the X router, the Y router, and the intellectual property eliminating the need for the operations of FIG. 1, therefore the latency of the packet in the router may be reduced.

The present invention illustrated in FIG. 6 may reduce the latency and may reduce manufacturing costs.

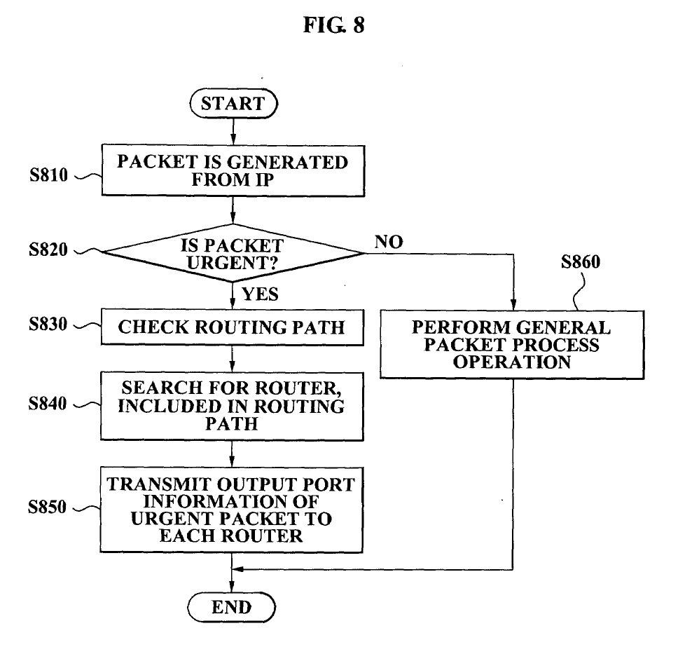

FIG. 8 is a flowchart illustrating an urgent NoC packet latency control method according to an exemplary embodiment of the present invention.

Referring to FIG. 8, it is determined whether a generated packet is an urgent packet in operation S820 after a packet is generated by an intellectual property in operation S810. In this case, the urgent packet is determined by using an urgent field value capable of discriminating whether the packet is urgent, the urgent field is being included in fields configuring of the packet.

In operation S860, a general packet process operation is performed when the packet, generated by the intellectual property, is not urgent.

In operations S830 and S840, a routing path is checked using a source address field and a destination address field included in the packet, and routers included in the routing path is looked-up when the packet, generated by the intellectual property, is urgent.

In operation S850, output port information is transmitted to each of the routers, included in the routing path. In this case, the output port information of the urgent packet is given priority and processed first when a plurality signals are simultaneously input to each of the routers since the output port information of the urgent packet corresponding to an advanced output port request, among input signals of an internal arbitration algorithm of the arbiter configuring the routers. Thus, latency of the each of the routers may be reduced since each of the routers connects input/output ports to be passed through by the urgent packet in advance.

In this case, the output port information of the urgent packet includes any one of an X router a Y router, and an intellectual property when an NoC operates according to an XY routing.

In this case, the urgent packet is sequentially processed in an order of generation of the urgent packet when urgent packets are generated by at least two intellectual properties. As described above, the urgent packet latency control method may be used for operations to be urgently processed, e.g., control information, status register update, and a lock operation.

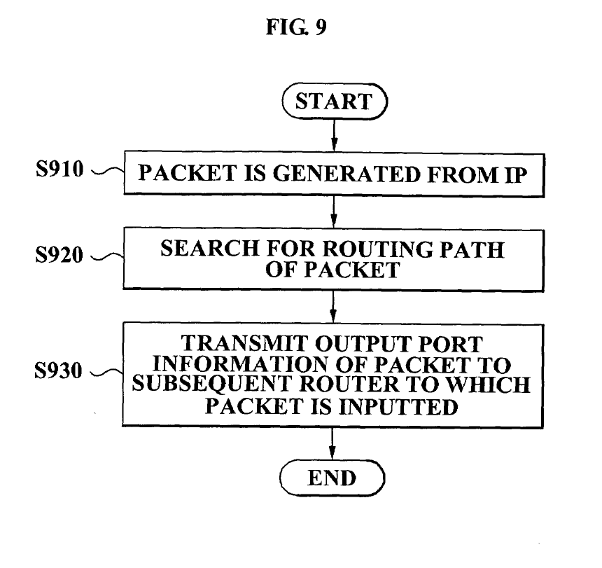

FIG. 9 is a flowchart illustrating an urgent NoC packet latency control method according to another exemplary embodiment of the present invention.

Referring to FIG. 9, a routing path is checked using a source address field and a destination address field included in a packet in operation S920, and a router included in the routing path is looked-up after the packet is generated by an intellectual property in operation S910.

In operation S930, output port information is transmitted to a subsequent router to which the packet is input, included in the routing path. In this case, the output port information of the packet is given priority and processed first when a plurality signals are simultaneously input to the router since the output port information of the packet corresponding to an advanced output port request, among input signals of an internal arbitration algorithm of the arbiter, configures the router. Thus, latency of a subsequent router may be reduced since a port where a packet is input is connected with a port where a packet is output in the subsequent router in advance using the output port information of the packet.

In this case, the output port information of the urgent packet includes any one of an X router, a Y router, and an intellectual property when an NoC operates according to an XY routing.

The urgent NoC packet latency control method according to the above-described embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

The urgent NoC packet latency control apparatus and the urgent NoC packet latency control method of the present invention may reduce latency of each router, and subsequently reduce latency of a packet to be transmitted to a destination since output port information of the urgent packet is transmitted to each of the routers, and input/output ports of each of the routers are connected in advance, the output port information being included in routing information of the urgent packet.

Also, according to the exemplary embodiments of the present invention, latency of a packet may be reduced and manufacturing costs may be reduced.

Also, according to the exemplary embodiments of the present invention, latency of a packet may be reduced by reducing wire complexity.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A network on chip (NoC) packet latency control apparatus comprising:
an urgent packet determination unit which determines whether a packet is an urgent packet based on a field of the packet;
an urgent packet path search unit which searches for at least one router, which is included in a routing path of the urgent packet, if the urgent packet determination unit determines that the packet is the urgent packet; and
an urgent packet path control unit which transmits output port information of the urgent packet to the router.

2. The NoC packet latency control apparatus of claim 1, wherein the output port information of the urgent packet corresponds to an advanced output port request among an input signal of the router.

3. The NoC packet latency control apparatus of claim 1, wherein the urgent packet path search unit searches for the router, which is included in the routing path, using a source address field and a destination address field included in the urgent packet.

4. The NoC packet latency control apparatus of claim 1, wherein an NoC operates according to static routing.

5. The NoC packet latency control apparatus of claim 4, wherein the output port information of the urgent packet comprises one of an X router, a Y router, and an intellectual property if the NoC operates according to an XY routing.

6. A network on chip (NoC) packet latency control apparatus comprising:
a packet path search unit which searches for a router, which is included in a routing path of a packet when the packet is input; and
a latency control apparatus which transmits output port information of the packet to a subsequent router to which the packet is input, included in the routing path.

7. The NoC packet latency control apparatus of claim 6, wherein the output port information of the packet corresponds to an advanced output port request among an input signal of the router.

8. The NoC packet latency control apparatus of claim 6, wherein the NoC packet latency control apparatus is a router connected to a master intellectual property which generates the packet.

9. The NoC packet latency control apparatus of claim 6, wherein the packet path search unit searches for the routing path using a source address field and a destination address field included in the packet.

10. The NoC packet latency control apparatus of claim 6, wherein the NoC operates according to static routing.

11. The NoC packet latency control apparatus of claim 6, wherein the output port information of the packet comprises one of an X router, a Y router and an intellectual property if the NoC operates according to an XY routing.

12. A network on chip (NoC) packet latency control method comprising:
determining whether a packet is an urgent packet based on a field of the packet;
searching for at least one router, which is included in a routing path of the urgent packet, if it is determined that the packet is the urgent packet; and
transmitting output port information of the urgent packet to the router, included in the routing path.

13. The NoC packet latency control method of claim 12, wherein the output port information of the urgent packet corresponds to an advanced output port request among an input signal of the router.

14. The NoC packet latency control method of claim 12, wherein the searching comprises searching for the at least one router, which is included in a routing path of the urgent packet, using a source address field and a destination address field included in the urgent packet.

15. The NoC packet latency control method of claim 12, wherein an NoC operates according to static routing.

16. The NoC packet latency control method of claim 15, wherein output port information of the urgent packet comprises one of an X router, a Y router, and an intellectual property if the NoC operates according to an XY routing.

17. A network on chip (NoC) packet latency control method comprising:
searching for a router, which is included in a routing path of a packet, if the packet is input; and
transmitting output port information of the packet to a subsequent router to which the packet is input, included in the routing path.

18. The NoC packet latency control method of claim 17, wherein the output port information of the packet corresponds to an advanced output port request among an input signal of the router.

19. The NoC packet latency control method of claim 17, wherein the NoC packet latency control method is performed in a router connected to a master intellectual property which generates the packet.

20. The NoC packet latency control method of claim 17, wherein the searching comprises searching for the router, which is included in the routing path of the packet using a source address field and a destination address field included in the packet.

21. The NoC packet latency control method of claim 17, wherein an NoC operates according to static routing.

22. The NoC packet latency control method of claim 21, wherein the output port information of the packet comprises one of an X router, a Y router, and an intellectual property if the NoC operates according to an XY routing.

23. A computer-readable storage medium storing a program for implementing a network on chip (NoC) packet latency control method, the method comprising:
determining whether a packet is an urgent packet based on a field of the packet;
searching for at least one router, which is included in a routing path of the urgent packet, if it is determined that the packet is the urgent packet; and
transmitting output port information of the urgent packet to the router, included in the routing path.
